(19) United States
(12) Patent Application Publication
(10) Pub. No.: US 2016/0368539 A1
(43) Pub. Date: Dec. 22, 2016

(54) STRUCTURAL COMPONENT

(71) Applicant: Röchling Automotive SE & Co. KG, Mannheim (DE)

(72) Inventor: Alexander SCHWARZ, Worms (DE)

(73) Assignee: Röchling Automotive SE & Co. KG, Mannheim (DE)

(21) Appl. No.: 15/177,533

(22) Filed: Jun. 9, 2016

(30) Foreign Application Priority Data
Jun. 22, 2015 (DE) 10 2015 109 936.5

(51) Int. Cl. B62D 29/04; B32B 15/04; B32B 3/26; B32B 25/10

(52) U.S. Cl. CPC B62D 29/04; B32B 25/10; B32B 15/04; B32B 3/266; B32B 2307/306; B32B 2605/00

(57) ABSTRACT

A multilayered structural component includes a structural component-base arrangement with at least one fiber layer made from a fiber layer material having a fiber reinforcement structure bonded with a thermoplastic binder, as well as at least one barrier film layer made from a plastic-based barrier film material. The at least one fiber layer and the at least one barrier film layer are arranged in a stacking direction, one above the other. The barrier film layer material comprises combustibility-reducing means such that the structural component with the barrier film layer has combustibility not greater than the structural component without the barrier film layer.

### CROSS REFERENCE TO RELATED APPLICATION(S)

This application claims priority to German Application No. 10 2015 109 936.5, filed Jun. 22, 2015. The entirety of the disclosure of the above-referenced application is incorporated herein by reference.

### BACKGROUND OF THE INVENTION

Field of the Invention

The present invention relates to a multilayered structural component, preferably a motor vehicle structural component, especially preferably a functional space paneling, such as an engine compartment or a floor paneling component of a motor vehicle, comprising a structural component base arrangement with at least one fiber layer with a fiber layer material which comprises a fiber reinforcement structure bonded with a thermoplastic binder, as well as at least one barrier film layer consisting of a plastic-based barrier film layer material, the at least one fiber layer and the at least one barrier film layer arranged in a stacking direction one above the other.

Description of the Related Art

One such structural component is known for example from document DE 10 2012 207 365 A1. This is provided for use in a motor vehicle, for instance as a paneling component, and comprises a structural component-base arrangement with a plurality of thermoplastically bonded fiber layers, as well as a water-repellent barrier film layer made from plastic, which is disposed between two fiber layers of the structural component-base arrangement. Such a component is distinguished in particular by its low weight and high natural stiffness and is therefore especially suited for use in motor vehicles, for example as a functional space paneling component, as for example an engine compartment or floor paneling component. However, actual suitability for use in a motor vehicle also definitively depends on the specific combustibility properties of these components, which depend primarily on the materials used in a specific component. In the structural components named above, in particular plastic-based barrier film layers have been shown to be problematic, as generally they have much greater combustibility than the structural component-base arrangement or the fiber layers of the structural component-base arrangement, and therefore, in association with the structural component-base arrangement, provide a component which has a greater combustibility in comparison to the structural component-base arrangement alone.

### SUMMARY OF THE INVENTION

In view of the problems known from the prior art, it is the task of the present invention to provide a structural component of the above type with a low combustibility.

This task is achieved in accordance with the invention by an above-defined structural component, wherein the barrier film layer material comprises combustibility-reducing means such that the structural component with the barrier film has combustibility not greater than the structural component without a barrier film layer.

In a structural component in accordance with the invention, the barrier film material is provided with combustibility-reducing means such that the at least one barrier film layer in association with the structural component-base arrangement provides a component with combustibility no greater than that of the structural component-base arrangement. According to the invention, a structural component-base arrangement in a structural component denotes all layers that are not barrier film layers. This designation however, should not be limited with respect to the relative arrangement of the at least one barrier film layer and the layers of the structural component-basis arrangement in the stacking direction.

As in the prior art, the barrier film layer is configured as a fluid-repellent protective layer. Furthermore, it can also have acoustic or thermal damping properties. These properties are of particular importance when the structural component is used as a functional space paneling component, as for instance an engine compartment or a floor paneling component in a motor vehicle. The acoustic damping effect of the structural component can be improved in that the at least one fiber layer has at least in sections a porosity of at least 70%. Within the scope of the present application, porosity is understood to mean the ratio of the hollow volume to the total volume of the material.

In accordance with the invention and from the standpoint of technical fire safety, the suitability of a structural component for use in a motor vehicle is preferably established when the structural component has a flammability classification of V-0 per UL94 and a maximal SE in accordance with ISO 3795.

UL94 is a test developed by the Underwriters Laboratories to determine the combustibility properties of plastics. In this test, five elongated specimens of defined geometry of a plastic to be determined are exposed two times each to a flame for 10 seconds. A test material is flammability-classified according to UL94 V-0 when:
a) None of the five specimens burns for longer than 10 seconds after exposure to the burner flame,
b) The total duration of flame formation in the 10 flame tests must not exceed 50 seconds,
c) None of the specimens may burn with flaming or glowing combustion up to the holder,
d) None of the test specimens produce drip flaming particles,
e) None of the samples may have glowing combustion that lasts longer than 30 seconds.

ISO 3795 is a test for motor vehicle components made from plastic to describe their combustibility properties. In this test as well, several plastic test specimens with preset geometry are exposed to a flame, and the combustion behavior with respect to duration is examined. A combustion classification SE in accordance with ISO 3795 means that the specimens can indeed be ignited, but that the flame is spontaneously extinguished before a specific portion of the specimen is burned up.

In order to bond the barrier film layer especially easily with a fiber layer, the barrier film layer material may be provided at least in sections with a material or may be formed from a material that is compatible with or preferably identical to the thermoplastic binder of the at least one fiber layer. A barrier film layer in this process can be hot-laminated to a fiber layer, for example.

In a further development of the invention, the barrier film layer material can comprise one of the following polymers: PP, PE, EVA, PA6, PA66, PA12, PET, PBT, PVAc, PVOH, PVC, PTFE, PVDF and/or a copolymer of at least one of these polymers or is formed therefrom. This further development is especially advantageous since these polymers or their copolymers can be used as thermoplastic binders in a fiber layer, which again makes the bonding of a barrier film layer to a fiber layer especially simple.

Proceeding from one such barrier film layer material, a reduction in combustibility can be attained in that the combustibility-reducing means of the barrier film layer material comprises a chemical modification of at least one polymer and/or a copolymer. The chemical modification can comprise a reactive integration of combustibility-reducing means into a polymer chain, and can occur both during manufacture of the barrier film layer material as well as during manufacture of the barrier film layer.

Alternatively or additionally, the combustibility-reducing means of the barrier film layer material can comprise a flame-inhibiting additive, which preferably is selected from: melamine cyanurate, melamine, ammonium polyphosphate, melamine polyphosphate, melamine-poly(aluminum phosphate), melamine-poly(magnesium phosphate), melamine-poly(zinc phosphate), aluminum hydroxide, magnesium hydroxide, red phosphorus, and an organic phosphorus compound, wherein the organic phosphorus compound preferably is selected from: aluminum diethyl phosphinate and its derivatives, triphenyl phosphate and its derivatives, triphenyl phosphite and its derivatives, bisphenol-A-bis(diphenyl phosphate) and resorcinol-bis(diphenyl phosphate).

As described above, the structural component-base arrangement denotes all layers of the structural component that are not a barrier film layer. However, the relative positioning in the stacking direction, of the specific layers in the stacking direction, should not thereby be limited. In a structural component according to the invention, the barrier film layer can be configured as a cover layer, that is, as a layer on the outside in the stacking direction and/or as a core layer, that is, as a layer disposed between two other layers.

Here the structural component-base arrangement need not necessarily comprise fiber layers only, but can in a further development of the invention also comprise at least one metal layer. This can serve for example as a heat shield, for instance in a structural component used in a motor vehicle in the region of a heat source, for instance an exhaust manifold. The metal layer can especially effectively display its effect as a heat shield when the metal layer is configured as a cover layer of the structural component. The metal layer can be configured in particular in the form of a metal plate or a metal foil as a cover layer, so it is advantageous when it is perforated, in particular micro-perforated, in order to allow the passage of sound through the metal layer to the at least one barrier film layer and/or a porous fiber layer. A perforation is understood here, to mean through-holes or slots in the metal layer. In a micro-perforation, the hole diameters or the slot widths are less than 1 mm, wherein both the hole diameters as well as the slot width or the hole/slot separations can be chosen depending on the acoustic frequencies that are expected, in order to achieve optimal sound absorption.

Furthermore, it would be possible to provide metal layers with a specific profile, in order to influence the mechanical properties of the structural component or to configure the porosity of the at least one fiber layer depending on its location. Such profiling can be done, for example, during manufacture of the structural component. For example, it can be manufactured by stacking the various layers in a press-forming die in the stacking direction, one above the other, and subsequently at elevated temperatures molding them under pressure. The press-forming die can here be configured to exert a non-uniform pressure, whereby both profiling of the metal foil layer and an uneven porosity of the at least one fiber layer can be created simultaneously. A defined, adjustable porosity can be assured here in that the fiber-layer blank is a pre-product with a fiber reinforcement structure thermoplastically bonded under pressure. Such a pre-product has the property of expanding when heated (lofting) and subsequently compacting in a defined manner.

Of course, a metal layer can also assume the function of a barrier film layer, but a plastic-based barrier film layer has numerous advantages in comparison to a metal layer. On the one hand, a plastic-based barrier film layer typically has a density of 0.9-1.7 g/cm³, which is much less than the density of generally used metal layers, such as aluminum foils (2.7 g/cm³) or steel foils (7.58 g/cm³). Consequently, by using a plastic-based barrier film layer, weight can be saved in comparison to a metal layer. On the other hand, a plastic-based barrier film layer, in comparison to a metal layer, can be processed more simply, as it can be thermoplastically deformed and therefore can achieve much greater degrees of deformation. In addition, as indicated above, the barrier film layer material is fitted to the thermoplastic binder of a fiber layer, so that bonding by means of hot lamination can be carried out simply. With a metal layer, on the other hand, a bonding agent must be used, so that processing is more laborious and expensive in comparison to a plastic-based barrier film layer.

The present invention in a further aspect relates to a motor vehicle, comprising a structural component in accordance with the invention.

### BRIEF DESCRIPTION OF THE DRAWING FIGURES

The present invention is explained in greater detail below with reference to the attached figures. Wherein:

FIG. 1 a sectional view of a structural component in accordance with the invention based on a first embodiment of the present invention and

FIG. 2 a sectional view of a structural component in accordance with the invention based on a second embodiment of the present invention.

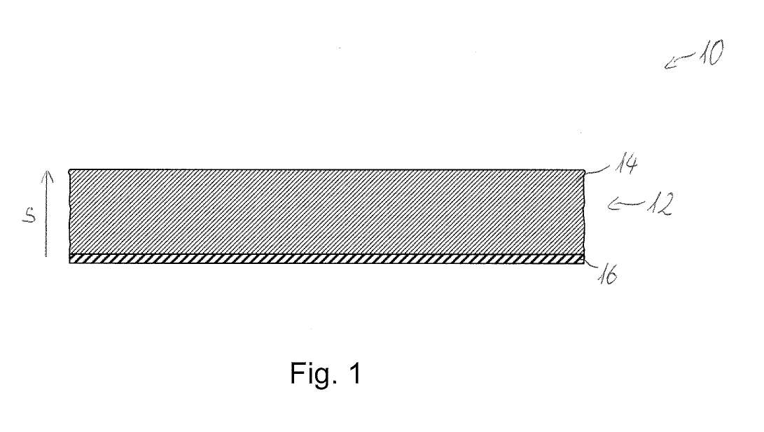

FIG. 1 shows a multilayered structural component quite generally denoted by reference number 10. This can be used, for example, as a functional space paneling component such as an engine compartment or floor paneling component of a motor vehicle and comprises a structural component-base arrangement 12 with a fiber layer 14 made from a fiber layer material, which comprises a fiber reinforcement structure bonded with a thermoplastic binder, as well as a barrier film layer 16, the barrier film layer 16 and the fiber layer 14 being arranged in a stacking direction S one above the other. The barrier film material comprises means that is combustibility-reducing such that the structural component 10 with the barrier film layer 16 has a combustibility not greater than the structural component 10 without the barrier film layer 16.

### DETAILED DESCRIPTION OF THE PREFERRED EMBODIMENTS

The barrier film layer 16 thus has combustibility-reducing means such that in association with the structural component-base arrangement 12, it provides a component whose combustibility is not greater than that of the structural component-base arrangement 12. In this way, it can be assured—from the standpoint of fire safety engineering—that the suitability of the structural component 10 or the structural component-base arrangement 12 for a specific usage, for instance for use in a motor vehicle, is not impaired by the barrier film layer 16.

The barrier film layer 16 can fulfill several functions in the structural component 10, for instance as a water repellent protective layer or a thermal or acoustic damping layer. Good thermal and acoustic damping properties are of particular importance when the structural component 10 is to be used as a functional space paneling component in a motor vehicle. The acoustic damping effect of the structural component can be improved if the fiber layer 14 is porous at least in sections, preferably with a porosity of at least 70%. Porosity is hereby understood to be the ratio of the hollow space volume to the total volume of a material.

From the standpoint of fire safety engineering, the suitability of the structural components 10 for use in a motor vehicle can be established if the structural component 10 has a flammability classification of V-0 in accordance with UL94, and a maximal SE in accordance with ISO 3795.

UL94 and ISO 3795 are standard tests for describing the combustibility properties of plastics. In these tests, several specimens with a defined geometry are exposed to a flame for given periods of time, and the combustion behavior of the specimens, in particular as regards combustion speed and extinguishment of the flame, are examined.

The barrier film layer 10 can be bonded to the fiber layer 14 in an especially simple manner if the barrier film layer material at least in sections comprises a material, or is formed from a material, which is compatible or even identical to the thermoplastic binder of the fiber layer 14. For example, the barrier film layer 16 can be hot laminated to the fiber layer 10.

The barrier film layer material can be formed from at least one of the following polymers: PP, PE, EVA, PA6, PA66, PA12, PET, PBT, PVAc, PVOH, PVC, PTFE, PVDF and/or a copolymer of at least one of these polymers or is formed therefrom. These polymers or their copolymers are especially advantageous since they can also serve as the basis for the thermoplastic binder of the fiber layer 14, which ultimately allows an especially simple bond between the barrier film layer 16 and fiber layer 14, for instance through hot lamination.

Proceeding from such a barrier film layer material, a combustibility reduction can be obtained if the combustibility-reducing means of the barrier film layer material comprises a chemical modification of at least one polymer and/or at least one copolymer. The chemical modification can comprise the reactive integration of combustibility-reducing agents in a polymer chain, and can occur both during manufacture of the barrier film layer material and during manufacture of the barrier film layer 16.

Alternatively or additionally, the combustibility-reducing means of the barrier film layer material can comprise a flame-inhibiting additive, which preferably is selected from: melamine cyanurate, melamine, ammonium polyphosphate, melamine polyphosphate, melamine-poly(aluminum phosphate), melamine-poly(magnesium phosphate), melamine-poly(zinc phosphate), aluminum hydroxide, magnesium hydroxide, red phosphorus and an organic phosphorus compound, wherein the organic phosphorus compound preferably is selected from: aluminum diethyl phosphinate and its derivatives, triphenyl phosphate and its derivatives, triphenyl phosphite and its derivatives, bisphenol-A-bis(diphenyl phosphate) and resorcinol-bis(diphenyl phosphate).

In the structural component 10 described herein, the structural component-base arrangement 12 denotes all layers of the structural components 10 which differ from the barrier film layer 16. In the structural component 10 according to the first embodiment, the structural component-base arrangement 12 comprises only the fiber layer 14, wherein the barrier film layer 16 is formed as a cover layer. This embodiment, however, should only serve to explain the underlying principles in accordance with the invention and in no case should be viewed as limiting with respect to the design of the structural component-base arrangement 12, the quantity of the barrier film layers 16, or the relative arrangement of the particular layers. Thus for example, the structural component-base arrangement can comprise a plurality of fiber layers and/or non-plastic-based barrier film layers, such as metal layers. Furthermore, a structural component is also conceivable in which a plastic-based barrier film layer is disposed between two further layers of the structural component in the stacking direction.

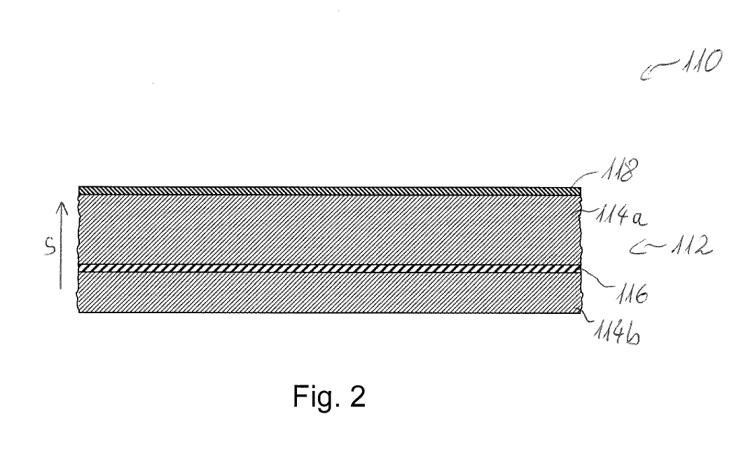

FIG. 2 shows a second embodiment of the present invention. In the following description of this embodiment, identical or functionally identical components or component sections are provided with the same reference numbers as in the description of the first embodiment, although increased by the number 100 and possibly by the suffix “a” or “b.” The second embodiment is described only to the extent that it differs from the first embodiment, to whose description otherwise reference is expressly made.

The structural component 110 shown in FIG. 2 according to the second embodiment differs from the structural component 10 of the first embodiment in that the structural component-base arrangement 112 has two fiber layers 114a and 114b, and a metal layer 118. Furthermore, in this structural component 110 a barrier film layer 116 is provided, but in contrast to the first embodiment is configured not as a cover layer, that is, as a layer lying on the outside in the stacking direction, but as a core layer, that is, as a layer disposed between two other layers. In this exemplary embodiment, the barrier film layer 116 is disposed between the two fiber layers 114a and 114b in the stacking direction S.

In the structural component 110, the metal layer 118 and the fiber layer 114b form the cover layers of this component. The metal layer 118 can serve, for example, as a heat shield, for instance when the structural component 110 is used in a motor vehicle in the region of a heat source, for instance the exhaust manifold.

The metal layer 118 can be configured in particular in the form of a metal plate or a metal film, and preferably has a thickness of less than 1 mm. In order to optimally utilize the sound absorbing properties of the fiber layers 114a and 114b and the barrier film layer 116, it is advantageous if the metal layer 118 is perforated, especially if it is micro-perforated, in order to be able to ensure the passage of sound through the metal layer 118 to the fiber layers 114a and 114b and the barrier film layer 116. Here a perforation is understood to be a through-hole or slot in the metal layer 118. In a micro-perforation the through-hole diameter or the slot width is less than 1 mm, wherein both the hole diameter as well as the slot widths, or the hole or slot separations, can be selected depending on the expected acoustic frequencies, in order to achieve maximal sound absorption.

In a modified exemplary embodiment, it would also be possible to provide the metal layer with a particular profile, in order to influence the mechanical properties of the structural component or to modify the porosity of the at least one fiber layer depending on location. Such profiling can be produced, for example, during manufacture of the structural component. This can be manufactured, for example, such that the various layers are stacked one upon the other in a press-form die and subsequently molded under pressure at an elevated temperature.

The press-form die can be configured to exert a non-uniform pressure, whereby both profiling of the metal film layer and non-uniform porosity of the at least one fiber layer can be created simultaneously. A defined, adjustable porosity can be assured in that the fiber layer blank is a pre-product with a fiber reinforcement structure bonded under pressure. Such a pre-product has the property of expanding under heat (“lofting”) and subsequently can be compacted in a defined manner.

Although the metal layer 118 can serve as a fluid-repellent protective layer or as a thermal and/or acoustic damping layer, and therefore could replace a plastic-based barrier film layer in a structural component not in accordance with the invention, the use of the barrier film layer 116 is preferred, since a plastic-based barrier film layer has numerous advantages in comparison to a metal layer. On the one hand, a plastic-based barrier film layer has a typical density of 0.9-1.7 g/cm³, which is markedly less than the density of the generally used metal layers, which are made for instance from aluminum foils (2.7 g/cm³) or steel foils (7.58 g/cm³). Consequently, use of a plastic-based barrier film layer can save weight in comparison to the metal layer. On the other hand, a plastic-based barrier film layer, in comparison to a metal layer, can be processed more simply, since it can be thermoplastically deformed and therefore much greater degrees of deformation can be achieved in comparison to metal layers. In addition, as indicated above, the barrier film layer material can be fitted to the thermoplastic binder of a fiber layer such that bonding can be provided simply, for instance by means of hot lamination. On the other hand, with a metal layer there always has to be a bonding agent, so that processing is more laborious and expensive in comparison to a plastic-based barrier film layer.

1. A multilayer structural component comprising:
a structural component-base arrangement with at least one fiber layer made from a fiber layer material, which comprises a fiber reinforcement structure bonded with a thermoplastic binder, as well as at least one barrier film layer made from a plastic-based barrier film layer material, the at least one fiber layer and the at least one barrier film layer being arranged one above the other in a stacking direction;
wherein the barrier film layer material comprises combustibility-reducing means such that the structural component with the barrier film layer has combustibility not greater than the structural component without a barrier film layer.

2. The structural component in accordance with claim 1,
wherein the structural component has a flammability classification of V-0 in accordance with UL94 and a maximal SE in accordance with ISO 3795.

3. The structural component according to claim 1,
wherein the barrier film layer material at least in sections comprises a material, or is formed from a material, that is compatible with or preferably identical to the thermoplastic binder of the at least one fiber layer.

4. The structural component according to claim 1,
wherein the barrier film layer material comprises at least one of the following polymers: PP, PE, EVA, PA6, PA66, PA12, PET, PBT, PVAc, PVOH, PVC, PTFE, PVDF and/or a copolymer of at least one of these polymers or is formed therefrom.

5. The structural component according to claim 4,
wherein the combustibility-reducing means of the barrier film layer material comprises a chemical modification of at least one polymer and/or at least one copolymer.

6. The structural component according to claim 1,
wherein the combustibility-reducing means of the barrier film layer material comprises a flame-inhibiting additive selected from: melamine cyanurate, melamine, ammonium polyphosphate, melamine polyphosphate, melamine-poly(aluminum phosphate), melamine-poly(magnesium phosphate), melamine-poly(zinc phosphate), aluminum hydroxide, magnesium hydroxide, red phosphorus, and an organic phosphorus compound.

7. The structural component according to claim 6,
wherein the organophosphorus compound is selected from aluminum diethyl phosphinate and its derivatives, triphenyl phosphate and its derivatives, triphenyl phosphite and its derivatives, bisphenol-A-bis(diphenyl phosphate) and resorcinol-bis(diphenyl phosphate).

8. The structural component according to claim 1,
wherein the at least one barrier film layer is designed as cover layer and/or as core layer.

9. The structural component according to claim 1,
wherein the structural component-base arrangement comprises at least one metal layer.

10. A motor vehicle comprising a structural component according to claim 1.

11. The structural component according to claim 9,
wherein the at least one metal layer is configured as a cover layer of the structural component.

12. The structural component according to claim 11,
wherein the at least one metal layer is perforated.

13. The structural component according to claim 11,
wherein the at least one metal layer is micro-perforated.
